(19) United States
(12) Patent Application Publication
(10) Pub. No.: US 2005/0015497 A1
(43) Pub. Date: Jan. 20, 2005

(54) Automatic IPv6 connect agent discovery using DNS

(76) Inventors: Hidetoshi Yokota, Saitama-Shi (JP); Shu Yamamoto, Cupertino, CA (US); Carl Williams, Palo Alto, CA (US); Kazuo Hashimoto, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/729,257

(22) Filed: Dec. 4, 2003

Related U.S. Application Data
(60) Provisional application No. 60/474,794, filed on May 29, 2003.

(51) Int. Cl. G06F 15/16

(52) U.S. Cl. 709/227

(57) ABSTRACT

An IPv6 enabled node finds an IPv6 connect agent by using a Domain Name System (DNS) server. The IPv6 enabled node sends a query to the DNS server and, in response, receives one or more identifiers of one or more IPv6 connect agents. In one embodiment, an identifier comprises the name of an IPv6 connect agent. In this embodiment, the IPv6 enabled node then sends a name of a desired IPv6 connect agent to the DNS server and, in response, receives the address of that IPv6 connect agent. The IPv6 enabled node is then able to engage in IPv6 communication using that IPv6 connect agent. In another embodiment, an identifier comprises the address of an IPv6 connect agent. In this embodiment, the IPv6 enabled node is able to engage in IPv6 communication using that IPv6 connect agent without any further contact with the DNS server.

### CROSS-REFERENCE TO RELATED APPLICATION

This application claims priority from U.S. provisional patent application Ser. No. 60/474,794 filed on May 29, 2003, entitled “Automatic IPv6 Connect Agent Discovery Using DNS.”

### FIELD OF INVENTION

The present invention relates generally to Internet Protocol communication, and specifically to facilitating Internet Protocol Version 6 (IPv6) communication over a network containing Internet Protocol Version 4 components using Domain Name System servers to automatically discover IPv6 connect agents.

### BACKGROUND OF INVENTION

There are currently two versions of Internet Protocol in use: the widely used but older Internet Protocol Version 4 (IPv4) and the less used but newer Internet Protocol Version 6 (IPv6). IPv6 is expected to gradually replace IPv4, but the two versions will coexist for a number of years during the transition period. Thus, enabling IPv6 communication over a network containing IPv4 components during the transition period when the two versions coexist is an important concern among users of the Internet. Such communication requires a connect agent to provide IPv6 connectivity to an IPv6 enabled node in an IPv4 network or in an IPv4 and IPv6 mixed network (a “mixed network”). What is needed are methods and systems for an IPv6 enabled node in an IPv4 or mixed network to automatically discover a connect agent that is capable of providing IPv6 connectivity across the IPv4 or mixed network. The methods and systems should not require an upgrade of the IPv4 or mixed network.

### SUMMARY OF INVENTION

In order to engage in IPv6 communication over a network containing IPv4 components, an IPv6 enabled node uses an IPv6 connect agent. An IPv6 enabled node finds an IPv6 connect agent by using a Domain Name System (DNS) server. The DNS server can be located either inside or outside the network containing the IPv6 enabled node.

The IPv6 enabled node sends a query to the DNS server and, in response, receives an identifier of at least one IPv6 connect agent. In one embodiment, an identifier comprises the name of an IPv6 connect agent. In this embodiment, the IPv6 enabled node then sends a name of a desired IPv6 connect agent to the DNS server and, in response, receives the address of that IPv6 connect agent. The IPv6 enabled node is then able to engage in IPv6 communication using that IPv6 connect agent. In another embodiment, an identifier comprises the address of an IPv6 connect agent. In this embodiment, the IPv6 enabled node is able to engage in IPv6 communication using that IPv6 connect agent without any further contact with the DNS server.

In another embodiment, when the IPv6 enabled node sends a query to the DNS server, it receives multiple IPv6 connect agent identifiers. In this embodiment, the IPv6 enabled node determines which IPv6 connect agent it wants to use. In one embodiment, this determination is based on selection criteria such as the order of the IPv6 connect agents in the list or the IPv6 connect agents' proximity to the IPv6 enabled node. In another embodiment, this determination is based on associated attributes of the IPv6 connect agents, such as bandwidth or speed.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1A is a block diagram illustrating a high level overview of an IPv6 enabled node in an IPv4 network using a Domain Name System (DNS) server external to the IPv4 network to discover a connect agent to enable IPv6 communication, according to one embodiment of the present invention.

FIG. 1B is a block diagram illustrating a high level overview of an IPv6 enabled node in an IPv4 section of an IPv4 and IPv6 mixed network using a DNS server external to the mixed network to discover a connect agent to enable IPv6 communication, according to one embodiment of the present invention.

FIG. 1C is a block diagram illustrating a high level overview of an IPv6 enabled node in an IPv4 section of an IPv4 and IPv6 mixed network using a DNS server in the mixed network to discover a connect agent to enable IPv6 communication, according to one embodiment of the present invention.

FIG. 2A is a flowchart illustrating steps for an IPv6 enabled node discovering the Internet address of a connect agent, according to one embodiment of the present invention.

FIG. 2B is a flowchart illustrating steps for an IPv6 enabled node discovering the Internet address of a connect agent, according to another embodiment of the present invention.

FIG. 3A is a flowchart illustrating steps for a DNS server facilitating the provision of the Internet address of a connect agent to the IPv6 enabled node, according to one embodiment of the present invention.

FIG. 3B is a flowchart illustrating steps for a DNS server facilitating the provision of the Internet address of a connect agent to the IPv6 enabled node, according to another embodiment of the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF PREFERRED EMBODIMENTS

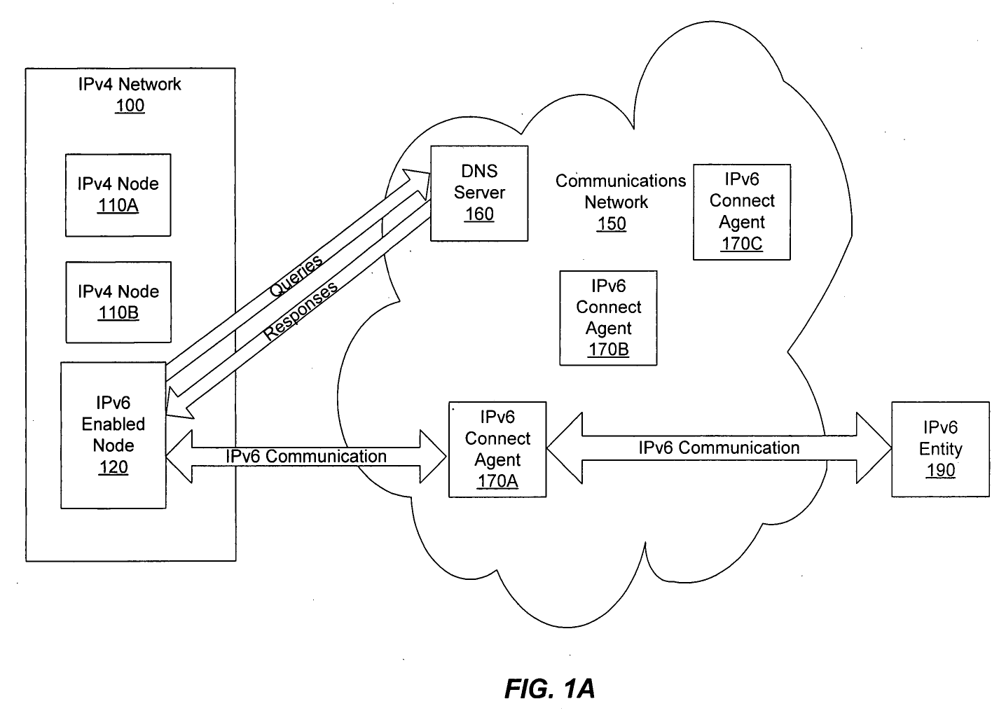

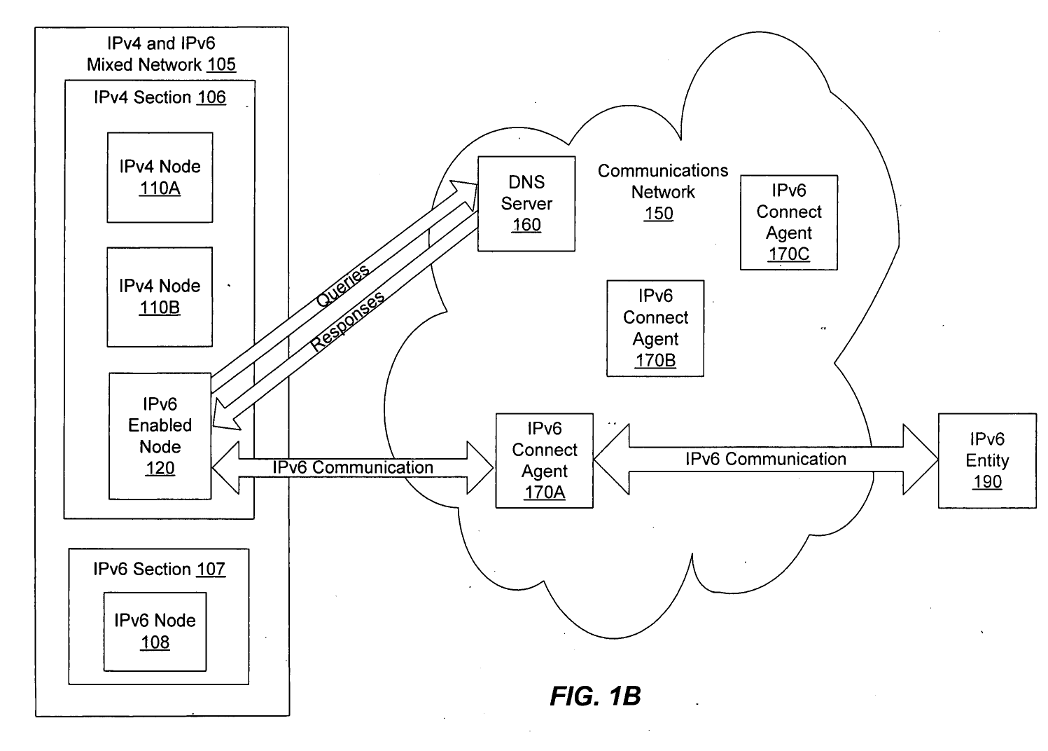

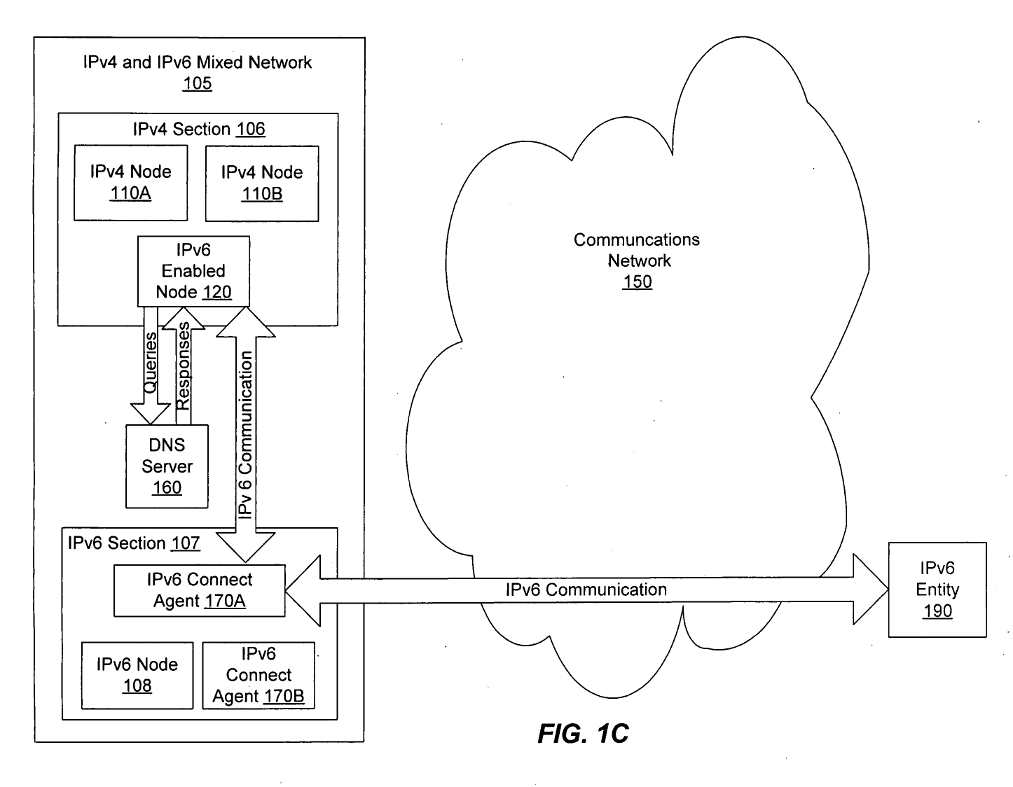

FIG. 1A is a block diagram illustrating a high level overview of an IPv6 enabled node in an IPv4 network using a Domain Name System (DNS) server external to the IPv4 network to discover a connect agent to enable IPv6 communication, according to one embodiment of the present invention. The illustrated embodiment includes an IPv4 network 100, a communications network 150, and an IPv6 entity 190. In the illustrated embodiment, IPv4 network 100 is coupled to communications network 150, and communications network 150 is coupled to IPv6 entity 190. Other embodiments, where the IPv4 network is replaced by an IPv4 and IPv6 mixed network, are discussed below with reference to FIGS. 1B and 1C.

In the illustrated embodiment, IPv4 network 100 includes two IPv4 nodes 110A and 110B and one IPv6 enabled node 120. This architecture is used only by way of example. While FIG. 1A illustrates two IPv4 nodes 110A and 10B, the present invention applies to any architecture containing one or more IPv4 nodes 110. While FIG. 1A illustrates one IPv6 enabled node 120, the present invention applies to any architecture containing one or more IPv6 enabled nodes 120.

Communications network 150 may include multiple processing systems and comprises a local area network (LAN), a wide area network (WAN; e.g., the Internet), and/or any other interconnected data path across which multiple devices may communicate. In the illustrated embodiment, communications network 150 includes one Domain Name System (DNS) server 160 and three IPv6 connect agents 170A, 170B, and 170C. This architecture is used only by way of example. While FIG. 1A illustrates three IPv6 connect agents 170A, 170B, and 170C, the present invention applies to any architecture containing zero or more IPv6 connect agents 170. When more than one IPv6 connect agent 170 is available, an IPv6 enabled node 120 has a choice regarding which IPv6 connect agent 170 to use. The process of selecting an IPv6 connect agent 170 is discussed in more detail below.

While the illustrated embodiment shows the DNS server 160 and the IPv6 connect agents 170 located in the same network, in another embodiment, they are located in different networks. While the illustrated embodiment shows the DNS server 160 and the IPv6 connect agents 170 located externally to the network containing IPv6 enabled node 120, in another embodiment, the DNS server 160 and/or the IPv6 connect agents 170 are located within the network containing IPv6 enabled node 120.

DNS server 160 is configured such that the nodes of the IPv4 network 100, including the IPv6 enabled node 120, can send queries to and receive responses from the DNS server 160.

IPv6 connect agent 170 is a node that includes the functionality required to enable an IPv6 enabled node 120 residing in an IPv4 network 100 (or in an IPv4 and IPv6 mixed network, as discussed below) to engage in IPv6 communications across the network. As shown in FIG. 1A, IPv6 connect agent 170A enables IPv6 communication between IPv6 enabled node 120 and IPv6 entity 190 across the IPv4 network 100 and the communications network 150. In one embodiment, the IPv6 connect agent 170 is implemented as a server. In another embodiment, the IPv6 connect agent 170 is implemented as a router. One of ordinary skill in the relevant art will recognize other implementation mechanisms for the IPv6 connect agent 170 in light of this document. Methods for providing IPv6 communication across an IPv4 or mixed network are known by those of ordinary skill in the relevant art, e.g., tunneling.

FIG. 1B is a block diagram illustrating a high level overview of an IPv6 enabled node in an IPv4 section of an IPv4 and IPv6 mixed network using a DNS server external to the mixed network to discover a connect agent to enable IPv6 communication, according to one embodiment of the present invention. FIG. 1B is similar to FIG. 1A except that the IPv4 network 100 of FIG. 1A has been replaced by the IPv4 and IPv6 mixed network 105 of FIG. 1B.

In the illustrated embodiment, mixed network 105 includes an IPv4 section 106 and an IPv6 section 107. IPv4 section 106 includes two IPv4 nodes 110A and 10B and one IPv6 enabled node 120. This architecture is used only by way of example. While FIG. 1B illustrates two IPv4 nodes 110A and 110B, the present invention applies to any architecture containing one or more IPv4 nodes 110. While FIG. 1B illustrates one IPv6 enabled node 120, the present invention applies to any architecture containing one or more IPv6 enabled nodes 120. IPv6 section 107 includes one IPv6 node 108. This architecture is used only by way of example. While FIG. 1B illustrates one IPv6 node 108, the present invention applies to any architecture containing one or more IPv6 nodes 108.

As shown in FIG. 1B, IPv6 connect agent 170A enables IPv6 communication between IPv6 enabled node 120 and IPv6 entity 190 across mixed network 105 and communications network 150.

FIG. 1C is a block diagram illustrating a high level overview of an IPv6 enabled node in an IPv4 section of an IPv4 and IPv6 mixed network using a DNS server in the mixed network to discover a connect agent to enable IPv6 communication, according to one embodiment of the present invention. FIG. 1C is similar to FIG. 1B except that the DNS server 160 and the IPv6 connect agent 170 have been moved from outside mixed network 105 to inside mixed network 105.

In the illustrated embodiment, mixed network 105 includes an IPv4 section 106, an IPv6 section 107, and a DNS server 160. IPv4 section 106 includes two IPv4 nodes 110A and 110B and one IPv6 enabled node 120. This architecture is used only by way of example. While FIG. 1C illustrates two IPv4 nodes 10A and 10B, the present invention applies to any architecture containing one or more IPv4 nodes 110. While FIG. 1C illustrates one IPv6 enabled node 120, the present invention applies to any architecture containing one or more IPv6 enabled nodes 120. IPv6 section 107 includes one IPv6 node 108 and two IPv6 connect agents 170A and 170B. This architecture is used only by way of example. While FIG. 1C illustrates one IPv6 node 108, the present invention applies to any architecture containing one or more IPv6 nodes 108. While FIG. 1C illustrates two IPv6 connect agents 170A and 170B, the present invention applies to any architecture containing one or more IPv6 connect agents 170.

As shown in FIG. 1C, IPv6 connect agent 170A enables IPv6 communication between IPv6 enabled node 120 and IPv6 entity 190 across mixed network 105 and communications network 150.

Methods and techniques of creating IPv6 enabled nodes 120 and connecting an IPv4 network 100 or mixed network 105 to a communications network 150 are known to those of ordinary skill in the relevant art. Note that the methods and systems described herein do not require the IPv4 elements of the IPv4 network 100 or mixed network 105 to be upgraded to IPv6 to allow the IPv6 enabled node 120 to undertake IPv6 communications.

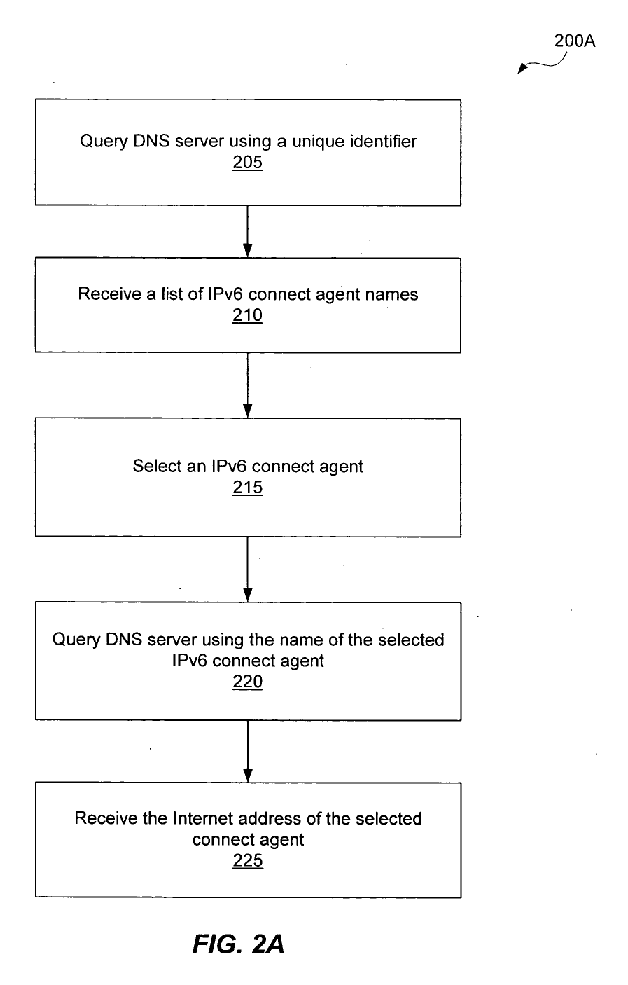

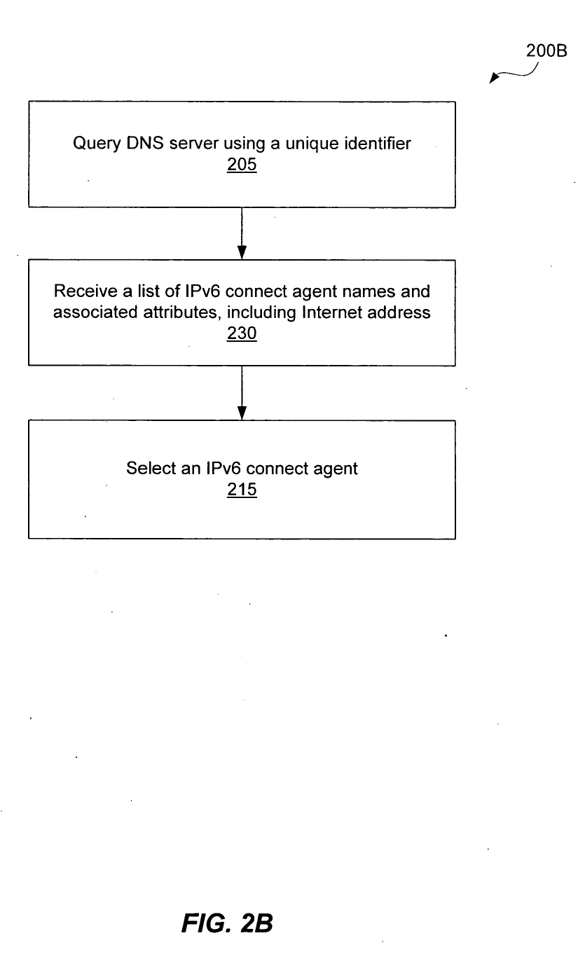

FIG. 2A illustrates steps for an IPv6 enabled node to automatically discover the Internet address of an IPv6 connect agent, according to one embodiment of the present invention. First, the IPv6 enabled node 120 queries 205 a DNS server 160 using an identifier. The DNS server 160 uses the identifier as a key to a DNS lookup to find an associated record. In one embodiment, the identifier is an IP address. In another embodiment, the identifier is a Media Access Control (MAC) address. In yet another embodiment, the identifier is any character string, for example as defined by the system administrator. Other examples of identifiers will be apparent to one of ordinary skill in the relevant art in light of this document. In one embodiment, the DNS lookup uses a Naming Authority Pointer (NAPTR) DNS resource record.

In response to the query, the IPv6 enabled node 120 receives 210 a list containing the names of zero or more IPv6 connect agents 170. The IPv6 connect agents 170 on the list are available to provide IPv6 communications to the IPv6 enabled node 120. If the list contains zero IPv6 connect agent 170 names, then no IPv6 connect agent 170 is available. A list of zero IPv6 connect agent 170 names can be implemented as an empty list or, alternatively, as the absence of a list. If the list contains at least one IPv6 connect agent 170 name, then at least one IPv6 connect agent 170 is available.

The IPv6 enabled node 120 then selects 215 an IPv6 connect agent 170 from the list. If the list of IPv6 connect agents 170 contains only one IPv6 connect agent 170, then the IPv6 enabled node 120 will select the IPv6 connect agent 170 listed. If the list of IPv6 connect agents 170 contains more than one IPv6 connect agent 170, then the IPv6 enabled node 120 will select an IPv6 connect agent 170 according to a set of selection criteria. In one embodiment, the selection criteria is simply the order of IPv6 connect agents 170 in the list such that the IPv6 connect agent 170 listed first is selected. In another embodiment, the IPv6 connect agent 170 that is physically closest to the IPv6 enabled node 120 is selected.

In yet another embodiment, the information received from DNS server 160 includes both IPv6 connect agent 170 names and associated attributes of each IPv6 connect agent 170. Examples of associated attributes are an IPv6 connect agent's location, bandwidth, speed, and supported communication protocols. Any combination of these or other associated attributes may also be used as selection criteria. Of course, the attributes and selection criteria described herein are only examples. Other examples of associated attributes and selection criteria will be apparent to those of ordinary skill in the relevant art in light of this document.

The IPv6 enabled node 120 then queries 220 the DNS server 160 using the name of the selected IPv6 connect agent 170. The DNS server 160 uses the name of the selected IPv6 connect agent 170 as a key to a DNS lookup to find an associated record. In one embodiment, the DNS lookup uses a Naming Authority Pointer (NAPTR) DNS resource record.

In response to the query, the IPv6 enabled node 120 receives 225 the Internet address of the selected IPv6 connect agent 170. The IPv6 enabled node 120 can then use the Internet address of the selected IPv6 connect agent 170 to communicate with the IPv6 connect agent 170 and thus engage in IPv6 communications.

FIG. 2B illustrates steps for an IPv6 enabled node to automatically discover the Internet address of an IPv6 connect agent according to another embodiment of the invention. First, the IPv6 enabled node 120 queries 205 a DNS server 160 using an identifier. In response to the query, the IPv6 enabled node 120 receives 230 a list containing IPv6 connect agent 170 names and associated attributes. In this embodiment, the associated attributes of an IPv6 connect agent 170 include at least the Internet address of that IPv6 connect agent 170.

The IPv6 enabled node 120 then selects 215 an IPv6 connect agent 170 from the list as described above. Once the IPv6 enabled node 120 has selected an IPv6 connect agent 170 from the list, the IPv6 enabled node 120 is able to use the Internet address of the selected IPv6 connect agent 170 to communicate with the IPv6 connect agent 170 and thus engage in IPv6 communications.

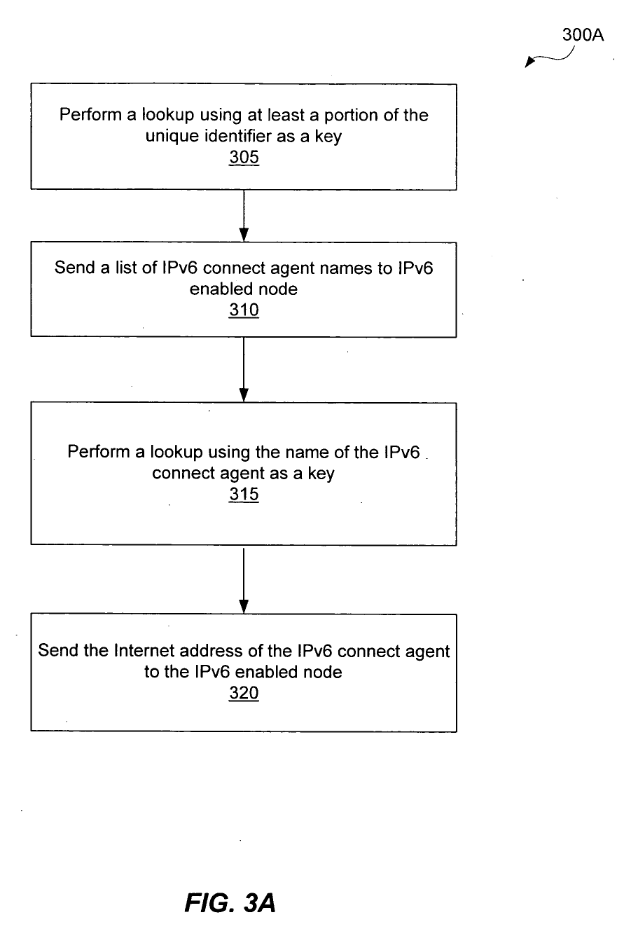

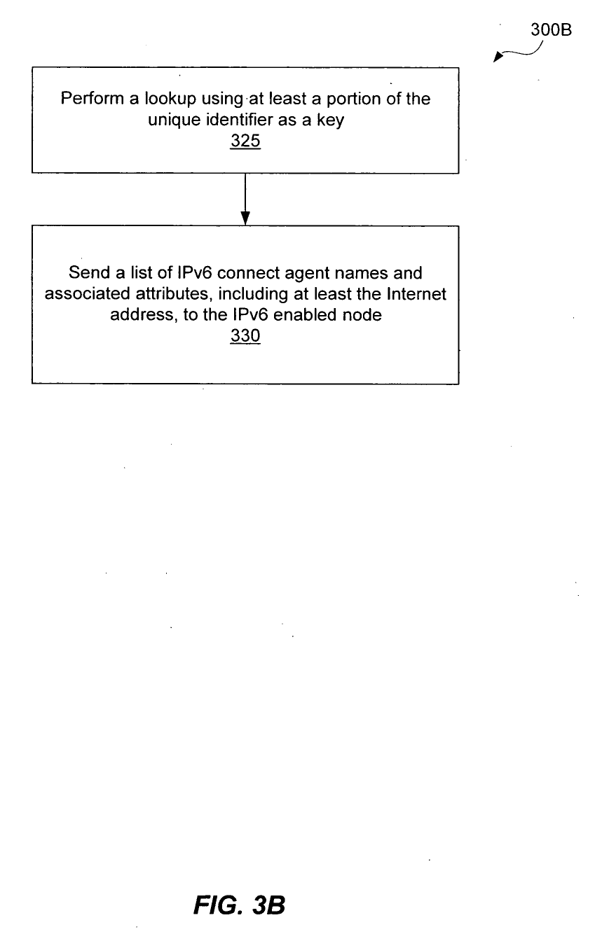

FIG. 3A illustrates steps of a DNS server facilitating the provision of the Internet address of an IPv6 connect agent to the IPv6 enabled node according to one embodiment of the present invention. In response to receiving a query from an IPv6 enabled node 120 including an identifier, the DNS server 160 performs a lookup using at least a portion of the identifier as a key. In one embodiment, the DNS server 160 stores records using the entire identifier supplied by the IPv6 enabled node 120. Thus, in this embodiment there is a one to one relationship between identifiers and stored records. In another embodiment, the DNS server 160 stores records using only a portion of the identifier; the other portions are replaced by wildcard characters. Thus, in that embodiment, there is a many to one relationship between identifiers and stored records. Hence, the identifiers of many IPv6 enabled nodes 120 may correspond to the same record. Each record contains a list of available IPv6 connect agent 170 names. In one embodiment, the DNS lookup uses a Naming Authority Pointer (NAPTR) DNS resource record.

The DNS server 160 then sends the IPv6 enabled node 120 the list of IPv6 connect agent 170 names. If the list contains zero IPv6 connect agents 170, then no IPv6 connect agent 170 is available. If the list contains at least one IPv6 connect agent 170, then at least one IPv6 connect agent 170 is available.

In response to receiving a query from the IPv6 enabled node 120 including the name of a selected IPv6 connect agent 170, the DNS server 160 performs a lookup using the name of the selected IPv6 connect agent 170 as a key. Each IPv6 connect agent 170 name corresponds to a record which contains the IPv6 connect agent's Internet address. In one embodiment, the DNS lookup uses a Naming Authority Pointer (NAPTR) DNS resource record.

The DNS server 160 then sends the IPv6 enabled node 120 the Internet address of the selected IPv6 connect agent 170. The IPv6 enabled node 120 is then able to use the Internet address of the selected IPv6 connect agent 170 to communicate with the IPv6 connect agent 170 and thus engage in IPv6 communications.

FIG. 3B illustrates steps of a DNS server facilitating the provision of the Internet address of an IPv6 connect agent to the IPv6 enabled node according to another embodiment of the present invention. In response to receiving a query from an IPv6 enabled node 120 including an identifier, the DNS server 160 performs a lookup using at least a portion of the identifier as a key, as discussed above. In one embodiment, the DNS lookup uses a Naming Authority Pointer (NAPTR) DNS resource record.

The DNS server 160 then sends the IPv6 enabled node 120 both the list of IPv6 connect agent 170 names and their associated attributes, including at least the Internet address. Thus, the IPv6 enabled node 120 can use the Internet address of a selected IPv6 connect agent 170 to communicate with the IPv6 connect agent 170 and thus engage in IPv6 communications.

As will be understood by those familiar with the art, the invention may be embodied in other specific forms without departing from the spirit or essential characteristics thereof. Likewise, the particular naming and division of the modules, features, attributes, methodologies, nodes, servers, connect agents, and other aspects are not mandatory or significant, and the mechanisms that implement the invention or its features may have different names, divisions, and/or formats. Furthermore, as will be apparent to one of ordinary skill in the relevant art, the modules, features, attributes, methodologies, nodes, servers, connect agents, and other aspects of the invention can be implemented as software, hardware, firmware, or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific programming language or for any specific operating system or environment. Accordingly, the disclosure of the present invention is intended to be illustrative, but not limiting, of the scope of the invention.

1. A method for an IPv6 enabled node to engage in IPv6 communication across a network containing IPv4 components, the method comprising:
the IPv6 enabled node sending a query to a Domain Name System server, the query identifying the IPv6 enabled node;
responsive to sending the query, the IPv6 enabled node receiving at least one identifier of at least one IPv6 connect agent from the Domain Name System server;
the IPv6 enabled node determining an IPv6 connect agent to use to engage in IPv6 communication across the network containing IPv4 components;
the IPv6 enabled node determining an address of that IPv6 connect agent; and
the IPv6 enabled node engaging in IPv6 communication across the network containing IPv4 components, using the determined address to communicate with that IPv6 connect agent.

2. The method of claim 1, wherein responsive to sending the query, the IPv6 enabled node further receives at least one associated attribute concerning at least one IPv6 connect agent from the Domain Name System server.

3. The method of claim 2, wherein:
at least one received attribute comprises an address of an associated IPv6 connect agent.

4. The method of claim 3, wherein the IPv6 enabled node determining an address of that IPv6 connect agent comprises:
gleaning the address from a received associated attribute concerning that IPv6 connect agent.

5. The method of claim 2, wherein:
at least one received attribute comprises information concerning a physical location of an associated IPv6 connect agent.

6. The method of claim 5 wherein the IPv6 enabled node determining an IPv6 connect agent to use to engage in IPv6 communication across the network containing IPv4 components comprises:
the IPv6 enabled node choosing the IPv6 connect agent that is physically closest to the IPv6 enabled node.

7. The method of claim 1, wherein the IPv6 enabled node determining an IPv6 connect agent to use to engage in IPv6 communication across the network containing IPv4 components comprises:
responsive to the IPv6 enabled node having received exactly one identifier of exactly one IPv6 connect agent from the Domain Name System server, the IPv6 enabled node choosing that one IPv6 connect agent.

8. The method of claim 1, wherein the IPv6 enabled node determining an IPv6 connect agent to use to engage in IPv6 communication across the network containing IPv4 components comprises:
the IPv6 enabled node choosing the IPv6 connect agent whose identifier the IPv6 enabled node received first.

9. The method of claim 1, wherein the IPv6 enabled node determining an address of that IPv6 connect agent comprises:
the IPv6 enabled node sending the received identifier of that IPv6 connect agent to the Domain Name System server; and
responsive to sending the received identifier, the IPv6 enabled node receiving the address of that IPv6 connect agent from the Domain Name System server.

10. The method of claim 1, wherein:
the query sent by the IPv6 enabled node to the Domain Name System server comprises an Internet Protocol address.

11. The method of claim 1, wherein:
the query sent by the IPv6 enabled node to the Domain Name System server comprises a Media Access Control address.

12. The method of claim 1, wherein:
the query sent by the IPv6 enabled node to the Domain Name System server comprises a character string.

13. A method for a Domain Name System server to provide to an IPv6 enabled node an address of an IPv6 connect agent, the method comprising:
the Domain Name System server receiving a query from an IPv6 enabled node, the query identifying the IPv6 enabled node;
responsive to the Domain Name System server receiving the query, the Domain Name System server determining at least one identifier of at least one IPv6 connect agent; and
the Domain Name System server sending to the IPv6 enabled node at least one identifier of at least one IPv6 connect agent.

14. The method of claim 13, wherein the Domain Name System server determining at least one identifier of at least one IPv6 connect agent comprises:
using the entire received query as a key to find a record in a lookup table.

15. The method of claim 13, wherein the Domain Name System server determining at least one identifier of at least one IPv6 connect agent comprises:
using a portion of the received query to find a record in a lookup table.

16. The method of claim 13, further comprising:
the Domain Name System server sending to the IPv6 enabled node an associated attribute concerning at least one IPv6 connect agent.

17. The method of claim 16, wherein:
at least one attribute comprises an address of an associated IPv6 connect agent.

18. The method of claim 16, wherein:
at least one associated attribute comprises information concerning a physical location of an associated IPv6 connect agent.

19. The method of claim 13, further comprising:
the Domain Name System server sending to the IPv6 enabled node at least one name of at least one IPv6 connect agent; and
the Domain Name System server receiving a name of a desired IPv6 connect agent from an IPv6 enabled node.

20. The method of claim 19, wherein the Domain Name System server determining at least one identifier of at least one IPv6 connect agent comprises:
using the received name of the desired IPv6 connect agent to find a record in a lookup table; and
gleaning from the found record an identifier of an IPv6 connect agent to send to the IPv6 enabled node.

21. The method of claim 13, wherein the Domain Name System server determining at least one identifier of at least one IPv6 connect agent comprises:
using a Naming Authority Pointer Domain Name System resource record.

22. The method of claim 13, wherein the query received by the Domain Name System server comprises an Internet Protocol address.

23. The method of claim 13, wherein the query received by the Domain Name System server comprises a Media Access Control address.

24. The method of claim 13, wherein the query received by the Domain Name System server comprises a character string.

25. A system for an IPv6 enabled node to engage in IPv6 communication across a network containing IPv4 components, the system comprising:
a software portion configured to send a query to a Domain Name System server, the query identifying the IPv6 enabled node;
a software portion configured to receive at least one identifier of at least one IPv6 connect agent from the Domain Name System server, responsive to having sent the query;
a software portion configured to determine an IPv6 connect agent to use to engage in IPv6 communication across the network containing IPv4 components;
a software portion configured to determine an address of that IPv6 connect agent; and
a software portion configured to engage in IPv6 communication across the network containing IPv4 components, using the determined address to communicate with that IPv6 connect agent.

26. The system of claim 25, further comprising a software portion configured to receive at least one associated attribute concerning at least one IPv6 connect agent from the Domain Name System server, responsive to having sent the query.

27. The system of claim 26, wherein:
at least one received attribute comprises an address of an associated IPv6 connect agent.

28. The system of claim 27, further comprising:
a software portion configured to glean the address from a received associated attribute concerning that IPv6 connect agent.

29. The system of claim 25, further comprising:
a software portion configured to send the received identifier of that IPv6 connect agent to the Domain Name System server; and
a software portion configured to receive the address of that IPv6 connect agent from the Domain Name System server, responsive to having sent the received identifier.

30. A system for a Domain Name System server to provide to an IPv6 enabled node an address of an IPv6 connect agent, the system comprising:
a software portion configured to, responsive to the Domain Name System server receiving a query from an IPv6 enabled node, the query identifying the IPv6 enabled node, determine at least one identifier of at least one IPv6 connect agent; and
a software portion configured to send to the IPv6 enabled node the least one identifier of the least one IPv6 connect agent.

31. The system of claim 30, further comprising:
a software portion configured to send to the IPv6 enabled node an associated attribute concerning at least one IPv6 connect agent.

32. The system of claim 31, wherein:
at least one attribute comprises an address of an associated IPv6 connect agent.

33. The system of claim 30, further comprising:
a software portion configured to send to the IPv6 enabled node at least one name of at least one IPv6 connect agent; and
a software portion configured to receive a name of a desired IPv6 connect agent from an IPv6 enabled node.

34. The system of claim 33, further comprising:
a software portion configured to use the received name of the desired IPv6 connect agent to find a record in a lookup table; and
a software portion configured to glean from the found record an identifier of an IPv6 connect agent to send to the IPv6 enabled node.

35. A computer readable medium containing a computer program product for an IPv6 enabled node to engage in IPv6 communication across a network containing IPv4 components, the computer program product comprising:
program code for sending a query to a Domain Name System server, the query identifying the IPv6 enabled node;
program code for receiving, responsive to sending the query, at least one identifier of at least one IPv6 connect agent from the Domain Name System server;
program code for determining an IPv6 connect agent to use to engage in IPv6 communication across the network containing IPv4 components;
program code for determining an address of that IPv6 connect agent; and
program code for engaging in IPv6 communication across the network containing IPv4 components, using the determined address to communicate with that IPv6 connect agent.

36. The computer readable medium of claim 35, the computer program product further comprising:
program code for receiving, responsive to sending the query, at least one associated attribute concerning at least one IPv6 connect agent from the Domain Name System server.

37. The computer readable medium of claim 36, wherein:
at least one received attribute comprises an address of an associated IPv6 connect agent.

38. The computer readable medium of claim 37, the computer program product further comprising:
program code for gleaning the address from a received associated attribute concerning that IPv6 connect agent.

39. The computer readable medium of claim 35, the computer program product further comprising:
program code for sending the received identifier of that IPv6 connect agent to the Domain Name System server; and
program code for receiving, responsive to sending the received identifier, the address of that IPv6 connect agent from the Domain Name System server.

40. A computer readable medium containing a computer program product for a Domain Name System server to provide to an IPv6 enabled node an address of an IPv6 connect agent, the computer program product comprising:
program code for determining, responsive to the Domain Name System server receiving a query from an IPv6 enabled node, the query identifying the IPv6 enabled node, the Domain Name System server, at least one identifier of at least one IPv6 connect agent; and
program code for sending to the IPv6 enabled node the least one identifier of the least one IPv6 connect agent.

41. The computer readable medium of claim 40, the computer program product further comprising:
program code for sending to the IPv6 enabled node an associated attribute concerning at least one IPv6 connect agent.

42. The computer readable medium of claim 41, wherein:
at least one attribute comprises an address of an associated IPv6 connect agent.

43. The computer readable medium of claim 40, the computer program product further comprising:
program code for sending to the IPv6 enabled node at least one name of at least one IPv6 connect agent; and
program code for receiving a name of a desired IPv6 connect agent from an IPv6 enabled node.

44. The computer readable medium of claim 43, the computer program product further comprising:
program code for using the received name of the desired IPv6 connect agent to find a record in a lookup table; and
program code for gleaning from the found record an identifier of an IPv6 connect agent to send to the IPv6 enabled node.

45. A system for an IPv6 enabled node to engage in IPv6 communication across a network containing IPv4 components, the system comprising:
means for sending a query to a Domain Name System server, the query identifying the IPv6 enabled node;
means for receiving, responsive to having sent the query, at least one identifier of at least one IPv6 connect agent from the Domain Name System server;
means for determining an IPv6 connect agent to use to engage in IPv6 communication across the network containing IPv4 components;
means for determining an address of that IPv6 connect agent; and
means for engaging in IPv6 communication across the network containing IPv4 components, using the determined address to communicate with that IPv6 connect agent.

46. The system of claim 45, further comprising:
means for receiving, responsive to having sent the query, at least one associated attribute concerning at least one IPv6 connect agent from the Domain Name System server.

47. The system of claim 46, wherein:
at least one received attribute comprises an address of an associated IPv6 connect agent.

48. The system of claim 47, further comprising:
means for gleaning the address from a received associated attribute concerning that IPv6 connect agent.

49. The system of claim 45, further comprising:
means for sending the received identifier of that IPv6 connect agent to the Domain Name System server; and
means for receiving, responsive to having sent the received identifier, the address of that IPv6 connect agent from the Domain Name System server.

50. A system for a Domain Name System server to provide to an IPv6 enabled node an address of an IPv6 connect agent, the system comprising:
means for determining, responsive to the Domain Name System server having received a query from an IPv6 enabled node, the query identifying the IPv6 enabled node, at least one identifier of at least one IPv6 connect agent; and
means for sending to the IPv6 enabled node the least one identifier of the least one IPv6 connect agent.

51. The system of claim 50, further comprising:
means for sending to the IPv6 enabled node an associated attribute concerning at least one IPv6 connect agent.

52. The system of claim 51, wherein:
at least one attribute comprises an address of an associated IPv6 connect agent.

53. The system of claim 50, further comprising:
means for sending to the IPv6 enabled node at least one name of at least one IPv6 connect agent; and
means for receiving a name of a desired IPv6 connect agent from an IPv6 enabled node.

54. The system of claim 53, further comprising:
means for using the received name of the desired IPv6 connect agent to find a record in a lookup table; and
means for gleaning from the found record an identifier of an IPv6 connect agent to send to the IPv6 enabled node
